(19) United States
(12) Patent Application Publication
(10) Pub. No.: US 2009/0322863 A1
(43) Pub. Date: Dec. 31, 2009

(54) Distance information obtainment method in endoscope apparatus and endoscope apparatus

(75) Inventor: Ryo Takahashi, Saitama-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 12/457,938

(22) Filed: Jun. 25, 2009

(30) Foreign Application Priority Data
Jun. 26, 2008 (JP) 167249/2008

(51) Int. Cl. G06K 9/46; H04N 7/18

(52) U.S. Cl. 348/65; 382/106; 348/E07.085

(57) ABSTRACT

Distance information between an observation-target and each pixel of an imaging device is obtained in an endoscope apparatus. The endoscope apparatus includes a scope unit having an illumination-light illuminating unit and an imaging device, and a spectral image processing unit that generates a spectral estimation image signal of a predetermined wavelength by performing spectral image processing on an image signal output from the imaging device. The illumination-light illuminating unit illuminates the observation-target with illumination-light, and the imaging device images the observation-target by receiving light reflected from the observation-target illuminated with the illumination-light. The spectral image processing unit generates the spectral estimation image signal of the predetermined wavelength greater than or equal to 650 nm, as a spectral estimation image signal for obtaining distance information. Distance information representing a distance between the observation-target and each of the pixels is obtained based on the spectral estimation image signal for obtaining distance information.

### BACKGROUND OF THE INVENTION

1. Field of the Invention

The present invention relates to a distance information obtainment method for obtaining distance information between an observation target and an imaging device of a scope unit of an endoscope apparatus when the observation target is observed by using the endoscope apparatus. Further, the present invention relates to the endoscope apparatus.

2. Description of the Related Art

Conventionally, endoscope apparatuses that can observe tissue in the body cavities of patients are well known. Further, electronic endoscopes that obtain ordinary images of observation targets by imaging the observation targets in the body cavities illuminated with white light and display the ordinary images on monitors are widely used in medical fields.

In such endoscope apparatuses, various methods have been proposed to measure a distance between the observation target and the leading end of the scope unit that is inserted into the body cavity.

For example, Japanese Unexamined Patent Publication No. 3(1991) -197806 (Patent Literature 1) proposes a method of measuring the distance between the leading end of the scope unit and the observation target by illuminating the observation target with measurement light that is different from the illumination light by the scope unit.

Further, Japanese Unexamined Patent Publication No. 5(1993)-211988 (Patent Literature 2) proposes a method of measuring the three-dimensional form of the observation target based on interference fringes by projecting the interference fringes onto the observation target by the scope unit. In other words, distance information between each pixel of the imaging device and the observation target is measured based on the interference fringes.

However, in the method disclosed in Patent Literature 1, an additional light source for measuring the distance and an additional fiber are needed. Further, in the method disclosed in Patent Literature 2, a filter or the like for projecting the interference fringes onto the observation target needs to be provided in the scope unit. Therefore, the diameter of the scope unit increases. Further, since imaging of the observation target and measurement of the distance must be separately performed by switching operations, examination time becomes longer. Therefore, there is a problem that the burden of the patient increases. Further, since the light source, filter and the like need to be provided, the cost increases.

### SUMMARY OF THE INVENTION

In view of the foregoing circumstances, it is an object of the present invention to provide a distance information obtainment method and an endoscope apparatus that can reduce the cost without increasing the burden of patients.

A distance information obtainment method of the present invention is a distance information obtainment method, wherein distance information between an observation target and each pixel of an imaging device on which an image of the observation target is formed is obtained in an endoscope apparatus, and wherein the endoscope apparatus includes a scope unit having an illumination light illuminating unit that illuminates the observation target with illumination light and the imaging device that images the observation target by receiving reflection light reflected from the observation target that has been illuminated with the illumination light, and a spectral image processing unit that generates a spectral estimation image signal of a predetermined wavelength by performing spectral image processing on an image signal output from the imaging device of the scope unit, and wherein the spectral image processing unit generates, based on the image signal output from the imaging device of the scope unit, the spectral estimation image signal of the predetermined wavelength that is greater than or equal to 650 nm, as a spectral estimation image signal for obtaining distance information, and wherein the distance information between the observation target and each of the pixels of the imaging device is obtained based on the spectral estimation image signal for obtaining distance information.

An endoscope apparatus of the present invention is an endoscope apparatus comprising:

a scope unit that includes an illumination light illuminating unit that illuminates an observation target with illumination light and an imaging device that images the observation target by receiving reflection light reflected from the observation target that has been illuminated with the illumination light; and

a spectral image processing unit that generates a spectral estimation image signal of a predetermined wavelength by performing spectral image processing on an image signal output from the imaging device of the scope unit, wherein the spectral image processing unit generates, based on the image signal output from the imaging device, the spectral estimation image signal of the predetermined wavelength that is greater than or equal to 650 nm, as a spectral estimation image signal for obtaining distance information, the endoscope apparatus further comprising:

a distance information obtainment unit that obtains, based on the spectral estimation image signal for obtaining distance information, distance information representing a distance between the observation target and each pixel of the imaging device on which the image of the observation target is formed.

In the endoscope apparatus of the present invention, the spectral image processing unit may generate the spectral estimation image signal of the predetermined wavelength that is greater than or equal to 650 nm and less than or equal to 700 nm, as the spectral estimation image signal for obtaining distance information.

The endoscope apparatus of the present invention may further include a distance correction unit that performs, based on the distance information about each of the pixels obtained by the distance information obtainment unit, distance correction processing on the image signal output from the imaging device to correct the distance between the observation target and each of the pixels of the imaging device on which the image of the observation target is formed.

Further, the endoscope apparatus of the present invention may further include a distance information image generation unit that generates, based on the distance information about each of the pixels obtained by the distance information obtainment unit, an image representing the distance information.

Further, the endoscope apparatus of the present invention may further include a display unit that displays an ordinary image based on the image signal output from the imaging device or a spectral estimation image based on the spectral estimation image signal generated in the spectral image processing unit, and the display unit may display the image representing the distance information in the ordinary image or in the spectral estimation image.

Further, the endoscope apparatus of the present invention may further include a display unit that displays an ordinary image based on the image signal output from the imaging device or a spectral estimation image based on the spectral estimation image signal generated in the spectral image processing unit, and the display unit may display the image representing the distance information together with the ordinary image or with the spectral estimation image.

Further, the endoscope apparatus of the present invention may further include a display unit that displays an ordinary image based on the image signal output from the imaging device or a spectral estimation image based on the spectral estimation image signal generated in the spectral image processing unit, and the display unit may display the image representing the distance information alone at timing that is different from the timing of displaying the ordinary image or the spectral estimation image.

In the endoscope apparatus of the present invention, the display unit may display the image representing the distance information in a window that is different from a window that displays the ordinary image or the spectral estimation image.

In the endoscope apparatus of the present invention, the display unit may display an image that represents the distance information only about a specific pixel of the imaging device.

In the endoscope apparatus of the present invention, when a difference between distance information about a pixel of the imaging device and distance information about pixels in the vicinity of the pixel is greater than or equal to a predetermined threshold value, the display unit may display the pixel in such a manner that the difference is emphasized.

According to the distance information obtainment method and endoscope apparatus of the present invention, the spectral image processing unit generates, based on the image signal output from the imaging device of the scope unit, the spectral estimation image signal of the predetermined wavelength that is greater than or equal to 650 nm, as a spectral estimation image signal for obtaining distance information. Further, distance information representing the distance between the observation target and each of the pixels of the imaging device on which an image of the observation target is formed is obtained based on the spectral estimation image signal for obtaining distance information. Therefore, unlike conventional techniques, it is not necessary to provide an additional light source and a fiber for measuring distance and a filter or the like in the scope unit. Therefore, the diameter of the scope unit does not increase. Hence, the distance information is obtained without increasing the burden of the patient. Further, the cost can be reduced.

In the endoscope apparatus of the present invention, when the spectral image processing unit generates the spectral estimation image signal of the predetermined wavelength that is greater than or equal to 650 nm and less than or equal to 700 nm, as the spectral estimation image signal for obtaining distance information, more accurate distance information can be obtained. The reason will be described later.

Further, when the distance correction unit performs, based on the distance information about each of the pixels obtained by the distance information obtainment unit, distance correction processing on the image signal output from the imaging device to correct the distance between the observation target and each of the pixels of the imaging device on which the image of the observation target is formed, it is possible to obtain an image of the observation target, supposing that all the pixels of the imaging device are equidistant from the observation target. Hence, it is possible to prevent misdiagnosis of judging, as a lesion, a region that is dark simply because the observation target is far from the pixel of the imaging device, and which is not a lesion.

Further, when the distance information image generation unit generates, based on the distance information about each of the pixels obtained by the distance information obtainment unit, an image representing the distance information, and the display unit displays image representing the distance information in an ordinary image or a spectral estimation image, it is possible to recognize an uneven pattern (projection/depression) in the ordinary image and the spectral estimation image.

Further, when the display unit displays the image representing the distance information together with the ordinary image or with the spectral estimation image, it is possible to recognize an uneven pattern (projection/depression) in the ordinary image and the spectral estimation image by the image representing the distance information. Further, it is possible to accurately recognize the characteristic of the ordinary image or the spectral estimation image.

Further, when the display unit displays an image that represents the distance information only about a specific pixel of the imaging device, it is possible to display the image representing the distance information only about the pixel about which an operator of the endoscope or the like wishes to recognize the distance information. Hence, it is possible to display the image according to the need of the operator.

Further, when a difference between distance information about a pixel of the imaging device and distance information about pixels in the vicinity of the pixel is greater than or equal to a predetermined threshold value, the display unit may display the pixel in such a manner that the difference is emphasized. When the difference is emphasized, a highly uneven region of the observation target is emphasized. Therefore, it is possible to direct attention of the operator or the like.

### BRIEF DESCRIPTION OF THE DRAWINGS

FIG. 1 is a schematic block diagram illustrating the configuration of an endoscope system using a first embodiment of an endoscope apparatus of the present invention;

FIG. 2 is a flowchart for explaining the action of the endoscope apparatus illustrated in FIG. 1;

FIG. 3 is a flowchart for explaining a method for calculating relative distance information in the endoscope system illustrated in FIG. 1;

FIG. 4 is a diagram illustrating spectral reflection spectra of hemoglobin Hb and oxyhemoglobin (oxygenated hemoglobin) HbO₂;

FIG. 5 is a diagram illustrating spectral reflection spectra of hemoglobin Hb and oxyhemoglobin HbO₂;

FIG. 6 is a schematic block diagram illustrating the configuration of an endoscope system using a second embodiment of an endoscope apparatus of the present invention;

FIG. 7 is a flowchart for explaining the action of the endoscope apparatus illustrated in FIG. 6; and

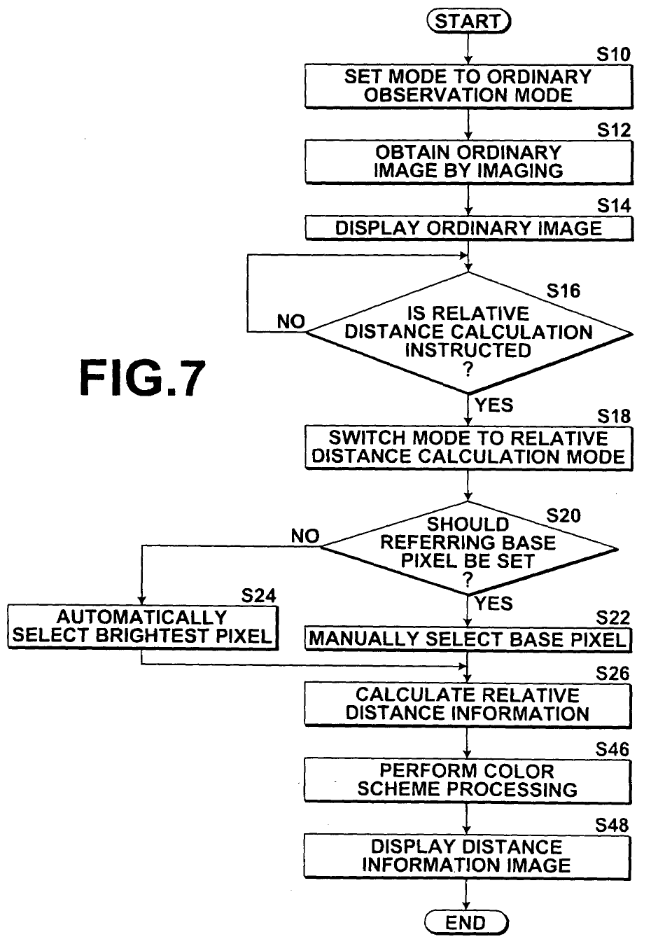

FIG. 8 is a diagram illustrating an example of an image representing relative distance information.

### DESCRIPTION OF THE PREFERRED EMBODIMENTS

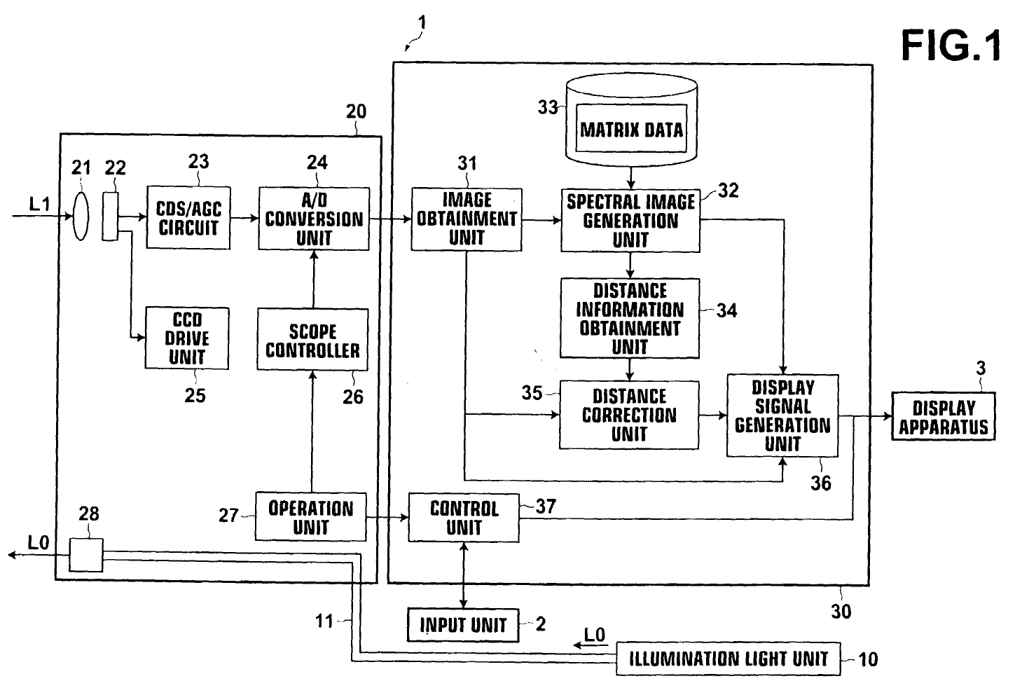

Hereinafter, an endoscope system 1 using a first embodiment of an endoscope apparatus according to the present invention will be described in detail with reference to drawings. FIG. 1 is a schematic diagram illustrating the configuration of an endoscope system 1 using the first embodiment of the present invention.

As illustrated in FIG. 1, the endoscope system 1 includes a scope unit 20, a processor unit 30, and an illumination light unit 10. The scope unit 20 is inserted into the body cavity of a patient (a person to be examined) to observe an observation target (an observation object or a region to be observed of the patient). The scope unit 20 is detachably connected to the processor unit 30. Further, the scope unit 20 is optically detachably connected to the illumination light unit 10 in which a xenon lamp that outputs illumination light L0 is housed. The processor unit 30 and the illumination light unit 10 may be structured as a unified body or as separate bodies.

The illumination light unit 10 outputs the illumination light L0 from the xenon lamp to perform normal observation. The illumination light unit 10 is optically connected to a light guide 11 of the scope unit 20, and the illumination light L0 enters the light guide 11 from an end of the light guide 11.

The scope unit 20 includes an image-formation optical system 21, an imaging device 22, a CDS/AGC (correlated double sampling/automatic gain control) circuit 23, an A/D (analog to digital) conversion unit 24, and a CCD (charge coupled device) drive unit 25, and each of the elements is controlled by a scope controller 26. The imaging device 22 is, for example, aCCD, a CMOS (complementary metal oxide semiconductor) or the like. The imaging device 22 performs photo-electric conversion on an image of the observation target, which has been formed by the image-formation optical system 21, to obtain image information. As the imaging device 22, a complementary-color-type imaging device that has color filters of Mg (magenta), Ye (yellow), Cy (cyan) and G (green) on the imaging surface thereof or a primary-color-type imaging device that has an RGB color filter on the imaging surface thereof may be used. In the description of the present embodiment, the primary-color-type imaging device is used. The operation of the imaging device 22 is controlled by the CCD drive unit 25. When the imaging device 22 obtains an image signal, the CDS/AGC (correlated double sampling/automatic gain control) circuit 23 performs sampling on the image signal, and amplifies the sampled image signal. Further, the A/D conversion unit 24 performs A/D conversion on the image signal output from the CDS/AGC circuit 23, and outputs the image signal after A/D conversion to the processor unit 30.

Further, the scope unit 20 includes an operation unit 27 that is connected to the scope controller 26. The operation unit 27 can set various kinds of operations, such as switching of observation modes.

Further, an illumination window 28 is provided at the leading end of the scope unit 20, and the illumination window 28 faces one of the ends of the light guide 11, the other end of which is connected to the illumination light unit 10.

The processor unit 30 includes an image obtainment unit 31, a spectral image generation unit 32, a storage unit 33, a distance information obtainment unit 34, a distance correction unit 35, a display signal generation unit 36, and a control unit 37. The image obtainment unit 31 obtains a color image signal of three colors of R, G and B that has been generated based on an ordinary image obtained by the scope unit 20. The ordinary image is obtained (imaged) by the scope unit 20 by illuminating the observation target with the illumination light L0. The spectral image generation unit 32 performs spectral image processing on the color image signal obtained by the image obtainment unit 31 to generate a spectral estimation image signal of a predetermined wavelength. The storage unit 33 stores spectral estimation matrix data that are used to perform the spectral image processing by the spectral image generation unit 32. The distance information obtainment unit 34 obtains distance information representing a distance between each pixel of the imaging device 22 and the observation target based on the spectral estimation image signal for distance information, which has been generated by the spectral image generation unit 32. The distance correction unit 35 performs, based on the distance information for each of the pixels obtained by the distance information obtainment unit 34, distance correction processing on the color image signal obtained by the image obtainment unit 31. The display signal generation unit 36 generates an image signal for display by performing various kinds of processing on the image signal after the distance correction, on which distance correction processing has been performed by the distance correction unit 35, or the like. The control unit 37 controls the whole processor unit 30. The operation of each of the elements will be described later in details.

Further, an input unit 2 is connected to the processor unit 30. The input unit 2 receives an input by an operator. The input unit 2 can set an observation mode in a manner similar to the operation unit 27 of the scope unit 20. Further, the input unit 2 receives an input of operation, such as distance information obtainment instruction, selection of a method for setting a base pixel (reference pixel), selection of a specific pixel as the base pixel and the like, which will be described later.

A display apparatus 3 includes a liquid crystal display apparatus, a CRT (cathode-ray tube) or the like. The display apparatus 3 displays an ordinary image, a spectral estimation image, a distance information image or the like based on the image signal for display output from the processor unit 30. The action of the display apparatus 3 will be described later in detail.

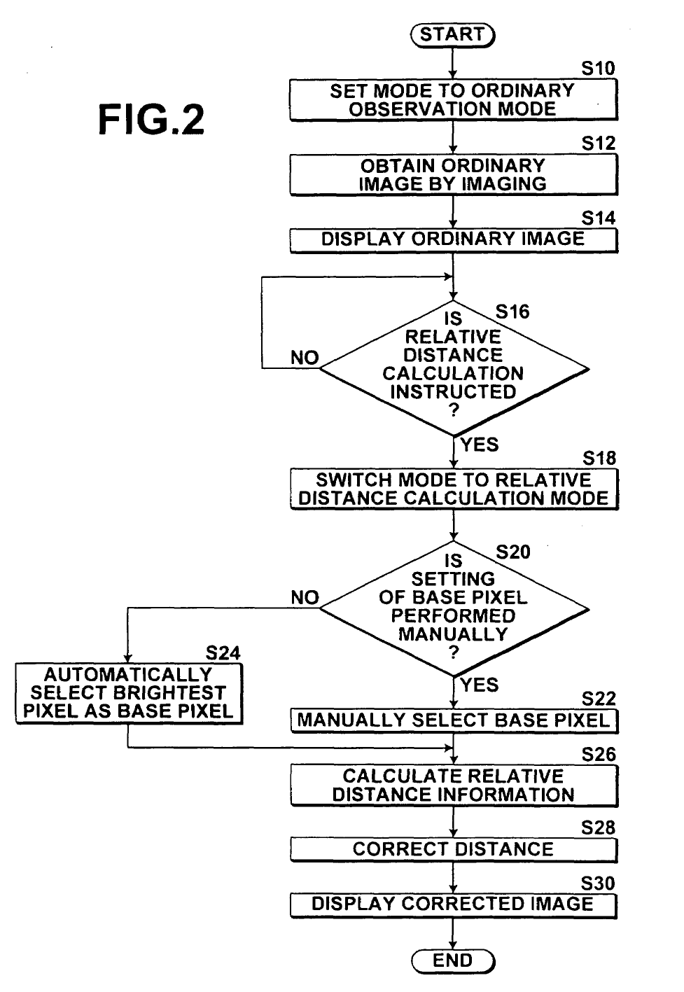

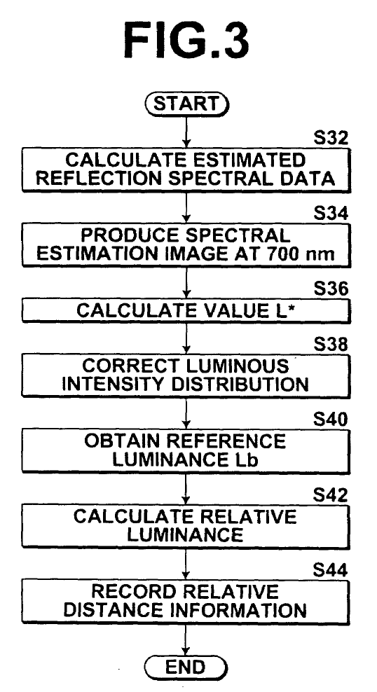

Next, the operation of the endoscope system of the present embodiment will be described with reference to the flowcharts illustrated in FIGS. 2 and 3. First, an operation in an ordinary observation mode will be described. In the ordinary observation mode, an ordinary image is displayed based on a color image signal obtained by illuminating the observation target with illumination light LO.

First, the ordinary observation mode is set (selected) by an operator at the operation unit 27 of the scope unit or the input unit 2 (step S10). When the ordinary observation mode is set, the illumination light L0 is output from the illumination light unit 10. The illumination light L0 is transmitted through the light guide 11, and output through the illumination window 28 to illuminate the observation target. Further, reflection light L1 is reflected from the observation target that has been illuminated with the illumination light L0, and the reflection light L1 enters the image-formation optical system 21 of the scope unit 20. The image-formation optical system 21 forms an ordinary image on the imaging surface of the imaging device 22. Further, the imaging device 22 is driven by the CCD drive unit 25 to perform imaging of an ordinary image. Accordingly, a color image signal representing the ordinary image is obtained (step S12). After the CDS/AGC circuit 23 performs correlated double sampling and amplification by automatic gain control processing on the color image signal, the A/D conversion unit 24 performs A/D conversion on the image signal on which the sampling and amplification have been performed to convert the analog signal into a digital signal. The digital signal is input to the processor unit 30.

The color image signal output from the scope unit 20 is obtained by the image obtainment unit 31 of the processor unit 30. The color image signal is output to the display signal generation unit 36. The display signal generation unit 36 performs various kinds of signal processing on the color image signal, and generates a Y/C signal composed of a luminance signal Y and chrominance signals C. Further, various kinds of signal processing, such as I/P conversion and noise removal, are performed on the Y/C signal to generate an image signal for display, and the image signal for display is output to the display apparatus 3. Further, the display apparatus 3 displays an ordinary image based on the input image signal for display (step S14).

After the ordinary image is displayed once as described above, the control unit 37 becomes a wait state, waiting for an instruction to calculate relative distance information (step S16). When the operator inputs an instruction to calculate relative distance information by using the input unit 2, the mode is switched to relative distance information calculation mode (step S18). When the mode is switched to the relative distance information calculation mode, the control unit 37 makes the display apparatus 3 display a message asking whether setting of a base pixel that is used to calculate relative distance information is performed manually or not (step S20). When the operator looks at the message, he/she uses the input unit 2 to select whether the base pixel is set manually or automatically.

When the operator selects manual setting of the base pixel, for example, a predetermined display pixel in an already-displayed ordinary image is selected by using a mouse or the like. Accordingly, a pixel in the imaging device 22 that corresponds to the selected display pixel is selected as the base pixel (step S22). Alternatively, the positions of pixels in the imaging device 22 may be set in advance as numerical value information, and the base pixel may be selected by an input of a numerical value by the operator.

In contrast, when the operator selects automatic setting of the base pixel, for example, the brightest (lightest) display pixel is automatically selected from display pixels of an already-displayed ordinary image. Accordingly, a pixel of the imaging device 22 that corresponds to the selected display pixel is selected as the base pixel (step S24).

Further, position information about the base pixel that has been manually or automatically selected as described above is input to the distance information obtainment unit 34. The distance information obtainment unit 34 calculates, based on reference luminance value Lb of the base pixel, relative distance information about pixels other than the base pixel (step S26). The method for calculating the relative distance information will be described later in detail.

Further, the relative distance information that has been calculated as described above is input to the distance correction unit 35. The distance correction unit 35 performs, based on the input relative distance information, distance correction processing on the color image signal input from the image obtainment unit 31. Further, the distance correction unit 35 outputs the image signal after distance correction to the display signal generation unit 36 (step S28).

Here, the distance correction processing is performed to correct a distance between the observation target and each pixel of the imaging device 22. For example, a change (fluctuation) in the lightness (brightness) of the pixel due to a distance between the observation target and each pixel of the imaging device 22 is cancelled. Specifically, for example, the value of each display pixel of an ordinary image is multiplied by a coefficient or the like corresponding to the value (magnitude) of the relative distance information to perform the distance correction processing as described above.

Further, the display signal generation unit 36 performs various kinds of signal processing on the input image signal after distance correction, and generates a Y/C signal composed of a luminance signal Y and chrominance signals C. Further, various kinds of signal processing, such as I/P conversion and noise reduction, are performed on the Y/C signal to generate an image signal for display. The display signal generation unit 36 outputs the image signal for display to the display apparatus 3. Further, the display apparatus 3 displays a distance correction image based on the image signal for display (step S30). The distance correction image is an image supposing that all of the pixels of the imaging device 22 are equidistant from the observation target. Therefore, it is possible to prevent a doctor or the like from erroneously diagnosing a dark region that is not a lesion, and which is dark just because the region is far from the pixel of the imaging device 22, as a lesion.

Here, the ordinary image and the distance correction image may be displayed simultaneously. Alternatively, the distance correction image may be displayed after the ordinary image is displayed.

Next, a method for calculating the relative distance information will be described in detail with reference to the flowchart illustrated in FIG. 3.

First, a color image signal obtained by the image obtainment unit 31 of the processor unit 30 in the ordinary observation mode is output also to the spectral image generation unit 32.

The spectral image generation unit 32 calculates estimated reflection spectral data based on the input color image signal (step S32). Specifically, the spectral image generation unit 32 performs a matrix operation represented by the following formula (1) on the color image signals R, G and B of each pixel. The spectral image generation unit 32 performs the matrix operation by using a matrix of 3×121, including all parameters of the spectral estimation matrix data, which are stored in the storage unit 33, and calculates estimated reflection spectral data (q1 though q121).

$$[ \begin{matrix}{q}_{1} \\ {q}_{2} \\ \\ {q}_{121}\end{matrix} ] = [ \begin{matrix}{k}_{1 r} & {k}_{1 g} & {k}_{1 b} \\ {k}_{2 r} & {k}_{2 g} & {k}_{2 b} \\ & ⋮ & \\ {k}_{121 r} & {k}_{121 g} & {k}_{121 b}\end{matrix} ] \times [ \begin{matrix}R \\ G \\ B\end{matrix} ] \qquad [ Formula ( 1 ) ]$$

Here, the spectral estimation matrix data are stored in advance, as a table, in the storage unit 33, as described above. Further, the spectral estimation matrix data are disclosed, in detail, in Japanese Unexamined Patent Publication No. 2003-093336, U.S. Patent Application Publication No. 20070183162, and the like. For example, in the present embodiment, the spectral estimation matrix data as shown in Table 1 are stored in the storage unit 33:

TABLE 1

| PARAMETER | kpr | kpg | kpb |
|---|---|---|---|
| p1 | k1r | k1g | k1b |
| . | . | . | . |
| . | . | . | . |
| . | . | . | . |
| p18 | k18r | k18g | k18b |
| p19 | k19r | k19g | k19b |
| p20 | k20r | k20g | k20b |
| p21 | k21r | k21g | k21b |
| p22 | k22r | k22g | k22b |
| p23 | k23r | k23g | k23b |
| . | . | . | . |
| . | . | . | . |
| . | . | . | . |
| p43 | k43r | k43g | k43b |
| p44 | k44r | k44g | k44b |
| p45 | k45r | k45g | k45b |
| p46 | k46r | k46g | k46b |
| p47 | k47r | k47g | k47b |
| p48 | k48r | k48g | k48b |
| p49 | k49r | k49g | k49b |
| p50 | k50r | k50g | k50b |
| p51 | k51r | k51g | k51b |
| p52 | k52r | k52g | k52b |
| . | . | . | . |
| . | . | . | . |
| . | . | . | . |
| p121 | k121r | k121g | k121b |

The spectral estimation matrix data in Table 1 include, for example, 121 wavelength band parameters (coefficient sets) p1 through p21, which are set by dividing the wavelength band of 400 nm to 1000 nm at intervals of 5 nm. Each of the parameters p1 through p121 includes coefficients kₚᵣ, k_{pg} and k_{pb} (p=1 through 121) for matrix operations.

Further, a spectral estimation image at the wavelength of 700 nm is generated based on the estimated reflection spectral data (step S34). Specifically, estimated reflection spectral data q61 of 700 nm are obtained, as an R component, a G component, and a B component of the spectral estimation image at the wavelength of 700 nm, from the estimated reflection spectral data (q1 through q121).

Further, XYZ conversion is performed on the R component, G component and B component of the spectral estimation image of the wavelength of 700 nm. Further, value L* is obtained for each pixel based on a Y value obtained by the XYZ conversion. Accordingly, a luminance image signal is generated (step S36).

Further, luminous intensity distribution correction processing is performed on the luminance image signal to calculate value 1* for each of the pixels. Accordingly, a luminance image signal after correction is generated (step S38). Here, the luminous intensity distribution correction processing corrects the unevenness in the light amount of the illumination light L0 when the illumination light L0 is output from the scope unit 20 onto a flat surface. For example, an image signal representing the unevenness in the light amount as described above should be obtained in advance, and a luminous intensity distribution correction image signal that can cancel the unevenness in the light amount should be obtained based on the obtained image signal representing the unevenness. Further, luminous intensity distribution correction processing should be performed, based on the luminous intensity distribution correction image signal, on the luminance image signal. In the present embodiment, the luminous intensity distribution correction processing that cancels the unevenness in the light amount as described above is performed. However, it is not necessary the luminous intensity distribution correction processing is performed in such a manner. For example, the luminous intensity distribution correction processing may be performed on the luminance image signal in such a manner that the peripheral area of the image becomes darker than the central area of the image so that the image becomes similar to an ordinary diagnosis image, which is normally observed by doctors or the like.

Next, value 1* corresponding to the base pixel is obtained, as reference luminance Lb, from the luminance image signal after correction. The value 1* is obtained based on position information about the base pixel of the imaging device 22 as described above (step S40).

Further, the value 1* corresponding to each of the base pixel and pixels other than the base pixel is divided by the reference luminance Lb to calculate the relative luminance Lr of each of the pixels, as the following formula shows (step S42):

Lr=value 1*/Lb.

Further, relative distance information D for each of the pixels is obtained by using the following formula (step S44):

D=1/Lr².

In the present embodiment, a spectral estimation image of the wavelength of 700 nm is used to obtain the relative distance information, as described above. However, it is not necessary that such a spectral estimation image is used. Any wavelength may be selected as long as the spectral estimation image of a predetermined wavelength greater than or equal to 650 nm is used. The reason will be described below.

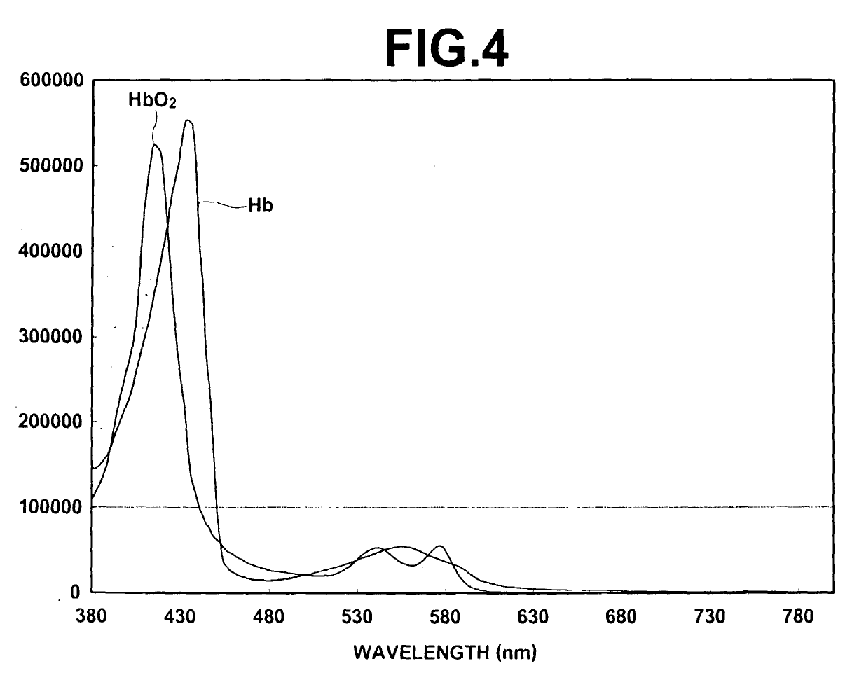

FIG. 4 is a diagram illustrating spectral reflection spectra of hemoglobin Hb and oxyhemoglobin HbO₂. These spectra are regarded as similar to the spectral reflection spectrum of blood vessels. Therefore, it is considered that the spectral reflection spectrum of mucous membranes, in which blood vessels are densely distributed, is similar to the spectral reflection spectra illustrated in FIG. 4.

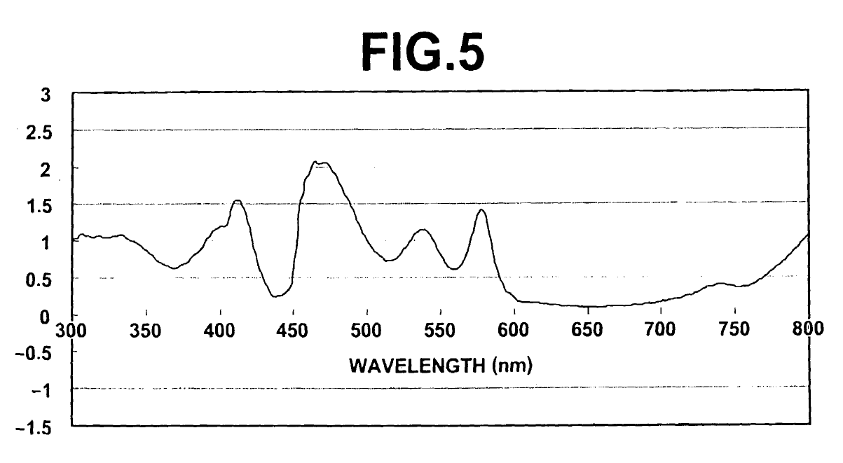

As FIG. 4 shows, both of the spectral reflection spectrum of hemoglobin Hb and that of oxyhemoglobin HbO₂ drop once in the vicinity of 450 nm, and gradually increase till the vicinity of 600 nm. After then, the spectral reflection spectra remain substantially at constant values. When the spectral reflection spectra of a specific wavelength lower than 600 nm is observed, the spectral reflection spectrum of hemoglobin Hb and that of oxyhemoglobin HbO₂ have different intensities (values) from each other. Therefore, it is possible to identify the difference is tissue based on the difference in the spectra. However, with respect to the wavelength greater than or equal to 650 nm, the intensity of the spectral reflection spectrum of hemoglobin Hb and that of oxyhemoglobin HbO₂ are constant. Further, a difference between the intensity of the spectral reflection spectrum of hemoglobin Hb and that of oxyhemoglobin HbO₂ is substantially zero in the range of 650 nm to 700 nm, as illustrated in FIG. 5. Therefore, the spectral reflection spectra in the range of 650 nm to 700 nm is not influenced by living body information absorption, and represents luminance information that depends only on distance.

Therefore, in the present invention, a spectral estimation image of a predetermined wavelength that is greater than or equal to 650 nm is used to obtain relative distance information. Here, it is more desirable that the spectral estimation image of a predetermined wavelength in the range of 650 nm to 700 nm is used.

Next, an operation in the spectral estimation image observation mode in the endoscope system of the present embodiment will be described. In the spectral estimation image observation mode, a spectral estimation image is displayed based on a color image signal obtained by illuminating an observation target with illumination light L0.

First, the spectral estimation image observation mode is selected by an operator by using the operation unit 27 of the scope unit 20 or the input unit 2. In the spectral estimation image observation mode, the steps from illumination of the illumination light L0 till obtainment of the color image signal are similar to the steps in the ordinary observation mode.

Further, the color image signal obtained by the image obtainment unit 31 is output to the spectral image generation unit 32.

In the spectral image generation unit 32, estimated reflection spectral data are calculated based on the input color image signal. The method for calculating the estimated reflection spectral data is similar to the aforementioned method for calculating the relative distance information.

After the estimated reflection spectral data are calculated, for example, three wavelength bands λ1, λ2 and λ3 are selected by an operation at the input unit 2. Accordingly, estimated reflection spectral data corresponding to the selected wavelength bands are obtained.

For example, when wavelengths 500 nm, 620 nm and 650 nm are selected as the three wavelength bands λ1, λ2 and λ3, coefficients of parameters p21, p45 and p51 in Table 1, which correspond to these wavelengths, are used to calculate estimated reflection spectral data q21, q45 and q51.

Further, an appropriate gain and/or offset is applied to each of the obtained estimated reflection spectral data q21, q45 and q51 to calculate pseudo color spectral estimation data s21, s45 and s51. These pseudo color spectral estimation data s21, s45 and s51 are used as image signal R′ of the R component of the spectral estimation image, image signal G′ of the G component of the spectral estimation image, and image signal B′ of the B component of the spectral estimation image, respectively.

These pseudo three color image signals R′, G′ and B′ are output from the spectral image generation unit 32 to the display signal generation unit 36. Further, the display signal generation unit 36 performs various kinds of signal processing on the pseudo three color image signals R′, G′ and B′, and generates a Y/C signal composed of a luminance signal Y and chrominance signals C. Further, various kinds of signal processing, such as I/P conversion and noise removal, are performed on the Y/C signal to generate an image signal for display. The image signal for display is output to the display apparatus 3, and the display apparatus 3 displays a spectral estimation image based on the input image signal for display.

In the above descriptions, the wavelengths 500 nm, 620 nm, and 650 nm were selected as the three wavelength bands λ1, λ2 and λ3. Such combinations of wavelength bands are stored in the storage unit 33 for each region to be observed, such as blood vessels and living body tissue for example. Therefore, a spectral estimation image of each region is generated by using a combination of wavelength bands that matches the region. Specifically, the sets of wavelengths λ1, λ2 and λ3 are, for example, eight combinations of wavelength bands, namely, standard set a, blood vessel B1 set b, blood vessel B2 set c, tissue E1 set d, tissue E2 set e, hemoglobin set f, blood—carotene set g, and blood—cytoplasm seth, or the like. The standard set a includes the wavelengths of 400 nm, 500 nm and 600 nm, and the blood vessel B1 set b includes the wavelengths of 470 nm, 500 nm, and 670 nm to extract blood vessels. The blood vessel B2 set c includes the wavelengths of 475 nm, 510 nm, and 685 nm to extract blood vessels. The tissue E1 set d includes the wavelengths of 440 nm, 480 nm, and 520 nm to extract a specific tissue. The tissue E2 set e includes the wavelengths of 480 nm, 510 nm, and 580 nm to extract a specific tissue. The hemoglobin set f includes the wavelengths of 400 nm, 430 nm, and 475 nm to extract a difference between oxyhemoglobin and deoxyhemoglobin. The blood—carotene set g includes the wavelengths of 415 nm, 450 nm, and 500 nm to extract a difference between blood and carotene. The blood—cytoplasm set h includes the wavelengths of 420 nm, 550 nm, and 600 nm to extract a difference between blood and cytoplasm.

In the endoscope system of the first embodiment of the present invention, in the ordinary observation mode, an ordinary image and a distance correction image are displayed. In the spectral estimation image observation mode, a spectral estimation image is displayed. However, processing in both of the modes may be performed, and the ordinary image, the distance correction image, and the spectral estimation image may be displayed simultaneously, or by switching displays.

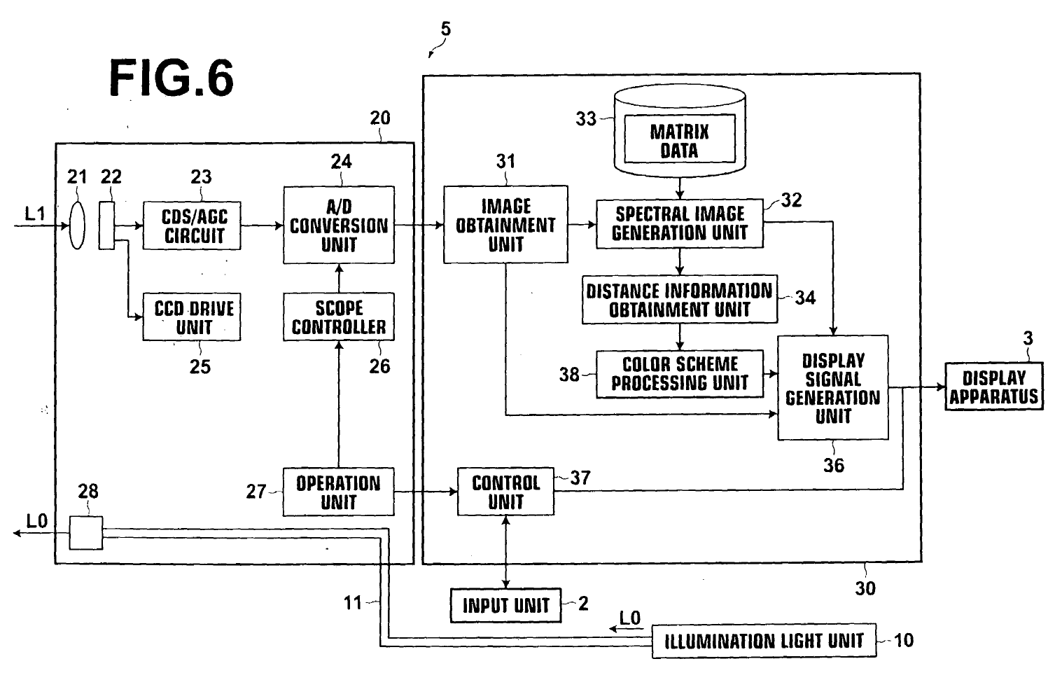

Next, an endoscope system using a second embodiment of the present invention will be described in detail. FIG. 6 is a schematic block diagram illustrating the configuration of an endoscope system 5 using the second embodiment of the present invention. In the endoscope system 5 using the second embodiment of the present invention, a method for using the relative distance information differs from the method in the endoscope system using the first embodiment of the present invention. Other structures of the endoscope system 5 are similar to the structures of the endoscope system using the first embodiment. Therefore, only elements different from the elements of the first embodiment will be described.

As illustrated in FIG. 6, the endoscope system 5 includes a color scheme processing unit 38 that generates an image signal representing relative distance information by performing color scheme processing on relative distance information about each of the pixels obtained by the distance information obtainment unit 34.

Further, the display signal generation unit 36 generates an image signal for display by combining (synthesizing) the image signal representing the relative distance information, generated by the color scheme processing unit 38, and the color image signal output from the image obtainment unit 31 or the pseudo three color image signal representing a spectral estimation image output from the spectral image generation unit 32.

Next, the operation of the endoscope system of the present embodiment will be described. First, an operation in the ordinary observation mode will be described. In the ordinary observation mode, an ordinary image is displayed based on a color image signal obtained by illuminating an observation target with illumination light L0.

The steps from obtaining an ordinary image by illuminating the observation target with the illumination light L0 till displaying the ordinary image (steps S10 through S14 in FIG. 2), and steps from switching to the relative distance calculation mode till calculation of the relative distance information (steps S16 through S26) are similar to the steps in the endoscope system of the first embodiment.

In the endoscope system 5 of the second embodiment, after the relative distance information D for each of the pixels is calculated, the calculated relative distance information D is input to the color scheme processing unit 38. Further, the color scheme processing unit 38 determines the color of each of the pixels. Specifically, the maximum value and the minimum value are selected from the relative distance information about all the pixels. Then, a color to be assigned to the maximum value and a color to be assigned to the minimum value are determined. Further, the base pixel is used as an origin (start point), and a color is assigned to each of the pixels so that the colors change in gradation based on the value of the relative distance information D toward the pixel of the maximum value and the pixel of the minimum value. Further, an image signal representing the relative distance information is generated so that each of the pixels represents the color information that has been assigned as described above. Further, the generated image signal is output to the display signal generation unit 36.

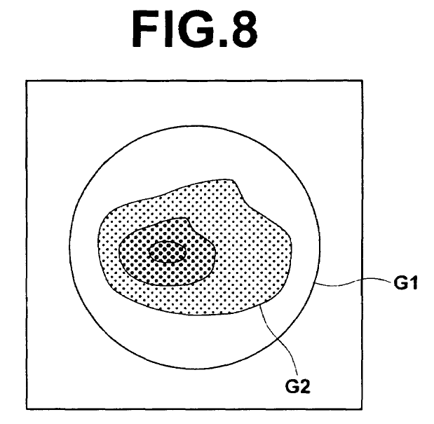

Further, the display signal generation unit 36 generates a combined image signal (synthesis image signal) by combining the image signal representing the relative distance information, generated by the color scheme processing unit 38, and the color image signal output from the image obtainment unit 31. Further, the display signal generation unit 36 performs various kinds of signal processing on the generated combined image signal, and generates a Y/C signal composed of a luminance signal Y and chrominance signals C. Further, various kinds of signal processing, such as I/P conversion and noise removal, are performed on the Y/C signal to generate an image signal for display. The image signal for display is output to the display apparatus 3. Further, the display apparatus 3 displays a synthesis image, based on the image signal for display, by superimposing an image representing the relative distance information on the ordinary image. An example of the synthesis image is illustrated in FIG. 8. In The synthesis image illustrated in FIG. 8, gradation image G2, representing relative distance information, is superimposed on ordinary image G1.

Further, with respect to the operation in the spectral estimation image observation mode, the action till obtaining the pseudo three color image signal is similar to the operation in the endoscope system of the first embodiment.

Further, the display signal generation unit 36 generates a combined image signal by combining the image signal representing the relative distance information generated by the color scheme processing unit 38 and the pseudo three color image signal output from the spectral image generation unit 32. Further, various kinds of signal processing are performed on the combined image signal, and a Y/C signal composed of a luminance signal Y and chrominance signals C is generated. Further, various kinds of signal processing, such as I/P conversion and noise removal, are performed on the Y/C signal to generate an image signal for display. The image signal for display is output to the display apparatus 3. The display apparatus 3 displays, based on the input image signal for display, a synthesis image in which an image representing the relative distance information is superimposed on the spectral estimation image.

In the endoscope system of the second embodiment, the color has been assigned to each of the pixels so that the colors change in gradation based on the size (value) of the relative distance information D. However, it is not necessary that the colors change in gradation. The colors may be assigned in a different manner as long as the colors change based on the values of the relative distance information.

Further, it is not necessary that colors are assigned to pixels based on the relative distance information D to fill the pixels or the image with the assigned colors. Alternatively, an image representing contour line or lines representing the range or ranges of relative distance information D of the same value may be superimposed on the ordinary image or the spectral estimation image. In other words, only the outline of the gradation image G2 illustrated in FIG. 8 is displayed.

Further, areas (ranges) of relative distance information D of different values from each other may be displayed by using different kinds of shadows from each other.

Further, it is not necessary that the image representing the relative distance information is displayed for all of the pixels. Instead, an image representing the relative distance information only about a pixel or pixels in a specific range may be displayed. Further, the pixel or pixels in the specific range may be determined, for example, by an operation of the operator by selecting a pixel in the ordinary image by using a pointer, such as a mouse.

Further, a pixel the relative distance information about which is different from the relative distance information about pixels surrounding the pixel by a predetermined threshold value or more may be identified, and the pixel may be displayed with emphasis.

Further, in the endoscope system of the second embodiment, the image representing the relative distance information is superimposed on the ordinary image or the spectral estimation image to display the combined image. However, it is not necessary that the image is displayed in such a manner. Alternatively, only an image representing the relative distance information may be displayed together with the ordinary image or the spectral estimation image.

In the endoscope system of the second embodiment, the ordinary image and the image representing the relative distance information are displayed in the ordinary image mode, and the spectral estimation image and the image representing the relative distance information are displayed in the spectral estimation image observation mode. Alternatively, processing in both of the modes may be performed, and the ordinary image, the spectral estimation image and the image representing the relative distance information may be displayed simultaneously or by switching. Alternatively, a synthesis image, in which an image representing relative distance information is superimposed on an ordinary image, and a synthesis image, in which an image representing relative distance information is superimposed on a spectral estimation image, may be displayed simultaneously or by switching. Further, a distance correction image may be displayed in a manner similar to the endoscope system of the first embodiment.

Further, in the endoscope systems of the first embodiment and the second embodiment, the relative distance information D about each of the pixels may be used, and processing for emphasizing the uneven pattern (projection/depression) of the observation target may be performed on the ordinary image or the spectral estimation image. Further, the image after emphasizing the uneven pattern may be displayed at the display apparatus 3.

Further, in the endoscope systems of the first embodiment and the second embodiment, the relative distance information D about each of the pixels may be used, and the direction of the leading end of the scope unit 20 facing the observation target may be obtained. Further, the obtained direction may be displayed at the display apparatus.

What is claimed is:

1. A distance information obtainment method, wherein distance information between an observation target and each pixel of an imaging device on which an image of the observation target is formed is obtained in an endoscope apparatus, and wherein the endoscope apparatus includes a scope unit having an illumination light illumination unit that illuminates the observation target with illumination light and the imaging device that images the observation target by receiving reflection light reflected from the observation target that has been illuminated with the illumination light, and a spectral image processing unit that generates a spectral estimation image signal of a predetermined wavelength by performing spectral image processing on an image signal output from the imaging device of the scope unit, and wherein the spectral image processing unit generates, based on the image signal output from the imaging device of the scope unit, the spectral estimation image signal of the predetermined wavelength that is greater than or equal to 650 nm, as a spectral estimation image signal for obtaining distance information, and wherein the distance information between the observation target and each of the pixels of the imaging device is obtained based on the spectral estimation image signal for obtaining distance information.

2. An endoscope apparatus comprising:
a scope unit that includes an illumination light illuminating unit that illuminates an observation target with illumination light and an imaging device that images the observation target by receiving reflection light reflected from the observation target that has been illuminated with the illumination light; and
a spectral image processing unit that generates a spectral estimation image signal of a predetermined wavelength by performing spectral image processing on an image signal output from the imaging device of the scope unit, wherein the spectral image processing unit generates, based on the image signal output from the imaging device, the spectral estimation image signal of the predetermined wavelength that is greater than or equal to 650 nm, as a spectral estimation image signal for obtaining distance information, the endoscope apparatus further comprising:
a distance information obtainment unit that obtains, based on the spectral estimation image signal for obtaining distance information, distance information representing a distance between the observation target and each pixel of the imaging device on which the image of the observation target is formed.

3. An endoscope apparatus, as defined in claim 2, wherein the spectral image processing unit generates the spectral estimation image signal of the predetermined wavelength that is greater than or equal to 650 nm and less than or equal to 700 nm, as the spectral estimation image signal for obtaining distance information.

4. An endoscope apparatus, as defined in claim 2, further comprising:
a distance correction unit that performs, based on the distance information about each of the pixels obtained by the distance information obtainment unit, distance correction processing on the image signal output from the imaging device to correct the distance between the observation target and each of the pixels of the imaging device on which the image of the observation target is formed.

5. An endoscope apparatus, as defined in claim 2, further comprising:
a distance information image generation unit that generates, based on the distance information about each of the pixels obtained by the distance information obtainment unit, an image representing the distance information.

6. An endoscope apparatus, as defined in claim 5, further comprising:
a display unit that displays an ordinary image based on the image signal output from the imaging device or a spectral estimation image based on the spectral estimation image signal generated in the spectral image processing unit, wherein the display unit displays the image representing the distance information in the ordinary image or in the spectral estimation image.

7. An endoscope apparatus, as defined in claim 5, further comprising:
a display unit that displays an ordinary image based on the image signal output from the imaging device or a spectral estimation image based on the spectral estimation image signal generated in the spectral image processing unit, wherein the display unit displays the image representing the distance information together with the ordinary image or with the spectral estimation image.

8. An endoscope apparatus, as defined in claim 5, further comprising:
a display unit that displays an ordinary image based on the image signal output from the imaging device or a spectral estimation image based on the spectral estimation image signal generated in the spectral image processing unit, wherein the display unit displays the image representing the distance information alone at timing that is different from the timing of displaying the ordinary image or the spectral estimation image.

9. An endoscope apparatus, as defined in claim 5, wherein the display unit displays the image representing the distance information in a window that is different from a window that displays the ordinary image or the spectral estimation image.

10. An endoscope apparatus, as defined in claim 6, wherein the display unit displays an image that represents the distance information only about a specific pixel of the imaging device.

11. An endoscope apparatus, as defined in claim 6, wherein when a difference between distance information about a pixel of the imaging device and distance information about pixels in the vicinity of the pixel is greater than or equal to a predetermined threshold value, the display unit displays the pixel in such a manner that the difference is emphasized.
